(19) United States
(12) Patent Application Publication
(10) Pub. No.: US 2002/0116218 A1
(43) Pub. Date: Aug. 22, 2002

(54) Customer-managing system, customer-managing method, order-receiving/customer-managing system and order-receiving/customer-managing method

(76) Inventors: Ryuichi Tanaka, Kanagawa (JP); Ryuji Suzuki, Tokyo (JP)

Correspondence Address: WILLIAM S. FROMMER, Esq., c/o FROMMER LAWRENCE & HAUG LLP, 745 Fifth Avenue, New York, NY, 10151, US

(21) Appl. No.: 10/079,613

(22) Filed: Feb. 19, 2002

(30) Foreign Application Priority Data
Feb. 20, 2001 (JP) P2001-043907

(51) Int. Cl. G06F 17/60

(52) U.S. Cl. 705/1

(57) ABSTRACT

The present invention provides a system and method that in a food/drink store or the like performs customer management would increase a customer's order-making desire. The system comprises a card reader that reads identification information for identifying a customer from a magnetic card having recorded therein the identification information, a display that displays information about serveable goods and/or articles served as the performance of the service, a first storage device for storing therein the identification information and an orders-made history information, by associating the former with the latter, representing the history of the orders made by the customer identified by the identification information on the goods and/or articles, a second storage device that has stored therein information about a plurality of the goods and/or articles, and a computer that, based on the orders-made history information having been stored in the first storage device by being associated with the identification information that has been read by the card reader, selects information about any one or ones of the goods and/or articles from among the information about a plurality of the goods and/or articles that has been stored in the second storage device, and that causes to display, on the display, the information about the selected goods and/or articles.

### BACKGROUND OF THE INVENTION

1. Field of the Invention

The present invention relates to a system and method that are arranged, in a food/drink store or the like, to allow it to manage a customer or to receive an order made by the customer.

2. Description of the Related Art

Conventionally, as a method that in a food/drink store increases a customer's desire to order, there was the method that gave the customer the points which correspond to the amount of money by which the customer made an order and that in correspondence with the level of those points decreased the amount of money that the store side claims when the same customer comes next time. Also, conventionally, the method for, in a food/drink store, showing the customer the food/drink that are serveable in the food/drink store was the one of showing every customer a common menu (e.g. a menu carrying the names of all serveable food/drink items).

Also, conventionally, as a method for in a food/drink store receiving an order made by the customer for an item of food/drink, there was the method wherein a calling bell was provided at a customer's seat. And the shop assistant (waiter, waitress, etc.) came to that customer's seat where that calling bell had rung and received the customer's order.

However, the method of giving the customer said points as in the prior art is arranged to evenly give the same profit with respect to every one of the customers. Therefore, there was a limit in respect of the effect to increase the customer's desire to order. Also, the method of as in the prior art showing a common menu to every customer resulted in that in case the kind of food/drink were many, a significantly large length of time was needed until the customer found out an item of food/drink that matched with his or her like. Simultaneously, since the same items of food/drink were evenly presented to any customer, there was not the effect of increasing the customer's desire to order, very much.

Further, in the order-receiving method that uses a calling bell as in the prior art, because the shop assistant couldn't hear the sound of the calling bell, the failure of the shop assistant to receive the order frequently occurred. Also, even in case the shop assistant could hear that sound, for example because all other shop assistants had been in the mid-course of receiving orders at other customers' seats, the delay for the shop assistant to receive the relevant order frequently occurred. Accordingly, it was impossible to quickly receive or accept an order made by the customer (If saying from the customer's side there were not a few cases where the customer was obliged to wait without making an order.

### SUMMARY OF THE INVENTION

The present invention has been made in view of the above-described conventional problems in a food/drink store, or the like and has an object to perform such a customer management as could further increase the customer's desire to order as well as quick reception of an order from the customer.

To attain the above object, taking up a food/store as an example, the present invention provides a customer-managing system that comprises reading means that reads identification information for identifying a customer from a recording medium having recorded therein the identification information, display means that displays information about food/drink, first storage means for storing therein the identification information and an orders-made history information by associating the former with the latter, representing the history of the order on the food/drink made by the customer identified by the identification information, second storage means that has had therein information about a plurality food/drink items, and processing means that, according to the orders-made history information having been stored in the first storage means by being associated with the identification information that has been read by the reading means, selects information about any one or ones of food/drink items from among the information about a plurality of food/drink items that has been stored in the second storage means, and that causes the display means to display, on the display means, the information about the selected food/drink items.

In this customer-managing system, when the identification information is read by the reading means from the recording medium having stored therein the identification information for identifying the customer, the following information is selected by the processing means according to the orders-made history information that has been stored in the first storage means by being associated with that identification information (i.e. the orders-made history information representing the history of the orders made by the customer for the food/drink items). Namely, the information about any item of food/drink of the information about a plurality of food/drink items that has been stored in the second storage means is selected. And the information about the thus-selected item of food/drink is displayed on the display means.

In this way, in units of an individual customer, on the display means, there are displayed the items of food/drink that have been selected according to the history of the order made by the customer about the food and drink items (this history shows which items of food/drink the customer made an order for in the past, namely which items of food/drink that customer likes). Therefore, it results in the fact that the customer who sees the display sees a specific menu that has been prepared in conformity with the like of the customer.

As a result of this, it becomes possible to more increase the customer's desire to order than in the case where the points are given to the customer as in the prior art or where a common menu is shown to every one of the customers as in the prior art. In addition, as a result of that, it becomes possible for the customer to more quickly find out an item of food/drink that fits the customer's like than in the case of showing every customer a common menu.

Next, taking up a food/drink store as an example, the present invention provides a customer-managing method that comprises an issuance step that issues a recording medium having recorded therein identification information for identifying a customer, a first storage step for storing therein the identification information and an orders-made history information by associating the former with the latter, representing the history of the order made for goods and/or articles by the customer identified by the identification information, a second storage step that has stored therein information about a plurality of food/drink items, a read step that reads out the identification information from the recording medium that has been issued in the issuance step, a selection step that, according to the orders-made history information having been stored in the first storage step in the way of being associated with the identification information that has been read in the read step, selects information about any one or ones of the goods and/or articles from among the information about a plurality of the goods and/or articles that has been stored in the second storage step, and a display step that displays information about the goods and/or articles that have been selected in the selection step.

In this customer-managing method, there is issued the recording medium having stored therein the identification information for identifying the customer. Also, that identification information and the orders-made history information representing the history of the orders made for the food/drink items by the customer identified by that identification information are stored in the way both are associated with each other. Also, this method stores the information about a plurality of food/drink items. And this method reads the identification information from that recording medium, and according to the orders-made history information stored in association with the thus-read identification information, selects information about any item of food/drink of the stored information about a plurality of food/drink items. Then, this method displays the thus-selected information about an item of food/drink.

In this way, in units of an individual customer, this method displays the item of food/drink that has been selected according to the history of orders made by the customer. Therefore, it results in the fact the customer who sees the display sees a specific menu that has been prepared in conformity with the like of that customer.

As a result of this, it becomes possible to further increase the customer's desire to order or for the customer to quickly find out the item of food/drink that conforms to the like of the customer.

Next, taking up a food/drink store as an example, the present invention provides an order-receiving/customer-managing system that comprises reading means that reads identification information for identifying a customer from a recording medium having recorded therein the identification information, first display means that displays information about food/drink, input means that performs an operation of ordering the item of goods whose information has been displayed on the first display means, second display means that displays the information indicating that the food/drink item has been ordered, first storage means for storing therein the identification information and an orders-made history information by associating the former with the latter, representing the history of the order for the item of food/drink made by the customer identified by the identification information, second storage means that has stored therein information about a plurality of food/drink items, first processing means that, according to the orders-made history information having been stored in the first storage means by being associated with the identification information that has been read by the reading means, selects information about any one or ones of food/drink items from among the information about a plurality of food/drink items that has been stored in the second storage means, and that causes the first display means to display the information about the selected item or items of food/drink, and second processing means that, according to the operation of the input means, causes the second display means to display the information indicating that the item of food/drink has been ordered.

In this order-receiving/customer-managing system, as in the case of the above-described customer-managing system of the present invention, the identification information is read out by the reading means from the recording medium having recorded therein the identification information for identifying the customer. When that reading is performed, according to the orders-made history information that has been stored in the first storage means in the way of being associated with that identification information, the information about any one or ones of the food/drink items of the information about a plurality of food/drink items stored in the second storage means is selected by the first processing means. Then, the information about the thus-selected item of food and drink is displayed on the first display means.

This is also similarly accompanied by the effect of increasing the customer's desire to order as well as the effect of enabling the customer to quickly find out the item of food/drink that fits the customer's own like.

Further, in this order-receiving/customer-managing system, according to the operation of the input means, there is displayed the information indicating that an item of food/drink has been ordered on the second display means through the operation of the second processing means.

Accordingly, when the customer makes an order for an item of food/drink by operating the input means, the shop assistant in the food/drink store can confirm the contents of that order by looking at the display on the second display means.

As a result of this, unlike the conventional order-receiving method that uses a calling bell, the shop assistant becomes able to quickly receive an order from the customer while the shop assistant is staying in the vicinity of the second display means.

Next, taking up a food/drink store as an example, the present invention provides order-receiving/customer-managing method that comprises an issuance step that issues a recording medium having recorded therein identification information for identifying a customer, a first storage step for storing therein the identification information and an orders-made history information by associating the former with the latter, representing the history of the orders for food/drink made by the customer identified by the identification information, a second storage step that has stored therein information about a plurality of food/drink items, a read step that reads out the identification information from the recording medium that has been issued in the issuance step, a selection step that, according to the orders-made history information having been stored in the first storage step by being associated with the identification information that has been read in the read step, selects information about any one or ones of food/drink items from among the information about a plurality of food/drink items that has been stored in the second storage step, and a first display step that displays information about food/drink items that have been selected in the selection step, and a second display step that, according to the operation of the input means for performing the operation of ordering food/drink items whose information has been displayed on the first display means, causes the second display means to display the information indicating that the food/drink item has been ordered.

In this order-receiving/customer-managing method, as in the case of the above-described customer-managing method of the present invention, a recording medium having had therein the identification information for identifying the customer is issued. Also, that identification information and the orders-made history information representing the history of orders for items of food/drink made by the customer that is identified by that identification information are stored by associating the former with the latter. Also, the method stores the information about a plurality of food/drink items. And the method reads out the identification information from the recording medium. According to the orders-made history information that has been stored by associating with that read-out identification information, the method then selects the information about any item of food/drink of the information about a plurality of the stored food/drink items, thereby, the method displays the information about the thus-selected food/drink items.

As a result of this, it also similarly becomes possible for the customer to further increase a desire to order as well as to quickly find out the item of food/drink that fits the customer's like.

Further, in this order-receiving/customer-managing method, according to the operation of the input means for performing the operation of ordering the items of food/drink whose information has been displayed on the first display means, there is displayed on the second display means the information indicating that the items of food/drink have been ordered.

Accordingly, when the customer orders the items of food/drink by operating the input means, the shop assistant of the food/drink store can confirm the contents of that order by looking at the display on the second display means.

As a result of this, unlike the conventional order-receiving method that uses a calling bell, the shop assistant becomes able to quickly receive the order made by the customer while the shop assistant keeps staying in the vicinity of the second display means.

### BRIEF DESCRIPTION OF THE DRAWINGS

FIG. 1 is a view illustrating an example of the entire construction of a system to which the present invention is applied;

FIG. 2 is a view illustrating an example of the outer-appearance construction of a customer card that is issued by a card issuance device of FIG. 1;

FIG. 3 is a view illustrating the items of customer information;

FIG. 4 is a view illustrating the items of the serveable goods information and an example of the accumulated serveable goods information;

FIG. 5 is a flow chart illustrating the customer card issuance process;

FIG. 6 is a view illustrating the flows of information and requests within the system of FIG. 1 during the customer card issuance process;

FIG. 7 is a flow chart illustrating the order reception/customer management process;

FIG. 8 is a flow chart illustrating the order reception/customer management process;

FIG. 9 is a view illustrating the flows of information and requests within the system of FIG. 1 during the order reception/customer management process; and

FIG. 10 is a view illustrating an example of the accumulated customer information.

### DESCRIPTION OF THE PREFERRED EMBODIMENT

Hereinafter, an explanation will be given of an example in which the invention has been applied to the reception of an order, as well as to the management of a customer, in each of the stores of a company that runs food/drink stores at a plurality of places (e.g. runs their chain stores at their relevant quarters).

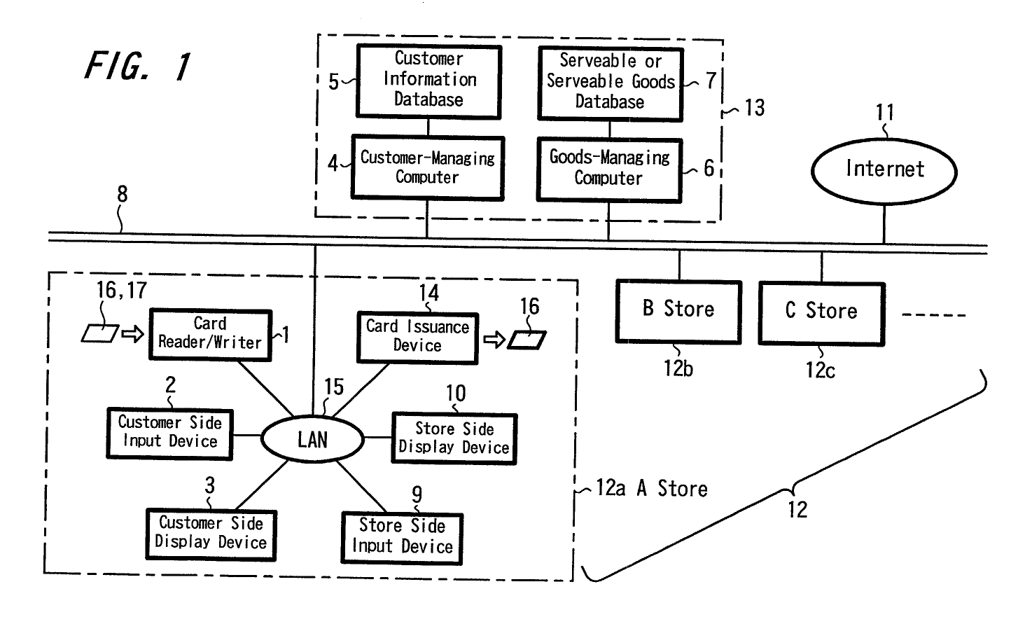

FIG. 1 illustrates an example of the entire construction of a system that has been configured for this company by applying the present invention. In this system, the stores 12 at their respective places, such as an A store 12a, B store 12b, C store 12c, . . . , and a head office 13 of the company that runs the stores 12 are connected together via an exclusive line network 8.

In each of the stores 12, as representatively shown regarding the A store 12a, the followings are provided. A card reader/writer 1, a customer side input device 2, a customer side display device 3, a store side input device 9, a store side display device 10, and a card issuance device 14. And these devices are connected to the exclusive line network 8 via a LAN (Local Area Network) (for example a wireless LANS) 15 located in the store.

The head office 13 is equipped with a computer 4 for use for management of the customers (hereinafter called “the customer-managing computer), a storage device 5 such as a hard disk drive that is used as a database for use for customer information (hereinafter called “the customer information database), a computer 6 for use for the management of food/drink that are served in each store 12 (hereinafter called “the goods-managing computer), and a storage device 7 such as a hard disk drive that is used as a database for use for food/drink information (hereinafter called “the serveable goods database”).

The customer-managing computer 4 and goods-managing computer 6 are each connected to the exclusive line network 8, while the customer information database 5 and serveable goods database 7 are connected to those computers 4 and 6, respectively. (As another example, such computers 4, 5, 6, and 7 can be connected, respectively in parallel with one another, to the exclusive line network 8. Or also, optionally, the customer information database 5 may be constructed using the same computer as the customer-managing computer 4, or optionally the service goods database 7 may be constructed using the same computer as the goods-managing computer 6, or optionally all the computers 4 to 7 may be constructed using the same computers.) The exclusive line network 8 is also connected to the Internet 11, too.

In each store 12, the card issuance device 14 is provided in a customer room or in the vicinity of the entrance at least one in number. The card issuance device 14 is for the purpose of issuing, for example, a magnetic card 16 (called, herein, “the customer card” that the customer uses in each relevant store 12).

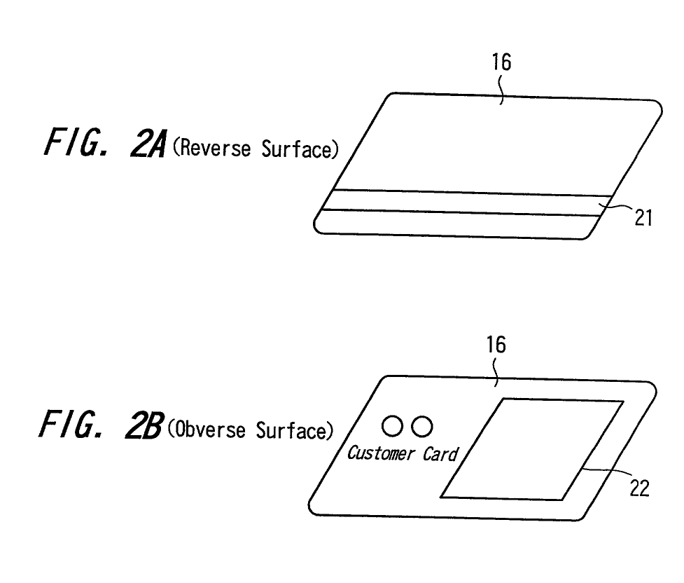

The customer card 16 is a card the size of which is that of a business card whose main body is, for example, made of plastic. FIG. 2 illustrates an example of the outer-appearance construction of this customer card 16. As illustrated in FIG. 2A, on the reverse-side surface of the customer card 16 there is coated a band-like magnetic material 21. Also, as illustrated in FIG. 2B, on the obverse-side surface of the customer card 16 there is provided a printing area 22 for printing thereon characters, figures, or symbols.

Inside the card issuance device 14 there are put a plurality of new customer cards 16 having neither magnetically-recorded information therein nor printings in the printing area 22. The card issuance device 14 magnetically records in a stored customer card 16 a customer ID that is the information for identifying each of the individual customers the year/date of birth that is personal information, and sends the customer card 16 having finished the recording of such customer ID or such personal information out into a card receiver opening formed in the surface of the main body of the card issuance device 14. The card issuance device 14 is equipped with an operation button for allowing the customer to request the issuance of the customer card 16. It is also equipped with an operation button for allowing the customer to input his/her own birth year and date.

Incidentally, the company that runs stores 12 can be arranged, other than to issue the customer card 16 by the use of the card issuance device 14, to also issue a customer card 17 concurrently used as a credit card, which is prepared by allied banks, credit companies etc., by an application in writing, for example. (That customer card 17 is the one prepared by recording the following information in a band-like magnetic material on the reverse surface. The information includes information, such as a credit card number, identifying an ordinary credit card, a customer ID that is different from any one of the IDs of the customer cards 16 or 17 that have already been issued by that time, and the customer's birth year and date .) On the obverse surface of the customer card 17 there are provided no such areas as the printing area 22 of FIG. 2, for having service information printed therein.

In each store 12, the card reader/writer 1, customer side input device 2, and customer side display device 3 are each provided one in number every table in the customer room. (In FIG. 1, for convenience of illustration, each of those machines 1, 2, and 3 is provided only one in number.) The card reader/writer 1 is equipped with a reading mechanism for magnetically reading the recorded information from the inserted customer card 16 or 17. Also,the card reader/writer 1 is equipped with a printing mechanism for printing characters, figures, symbols, etc. in the printing area 22 of FIG. 2 of the inserted customer card 16.

The customer side display device 3 is provided to display various items of information such as information about the food/drink that the store recommends the customers to take through the use of picture images, characters, etc. on a screen, such as a liquid crystal display, or the like. As that device 3 there is used a liquid crystal display, etc.

The customer side input device 2 is provided for the purpose of allowing the customer to perform the operation of making an order for an item or items of food/drink, and is therefore equipped with an operation button for selecting food/drink that the customer orders from among the items of food/drink that have been displayed on the customer side display device 3 and, in addition, for selecting the purchased quantity of that food/drink (how many persons the customer orders for), as well as an operation button for allowing the customer to finally decide the ordering contents of the food/drink that has been selected with that selection button. The customer side input device 2 is also equipped with an operation button for designating, as the answers of questionnaires, the items of food/drink that the customer will try to order in future although the customer does not order today.

In each store 12, the store side input device 9 and store side display device 10 are each provided at least one in number in the place where a shop assistant is standing by. The store side input device 9 is equipped with an operation button that is to be operated when the shop assistant has received an order from the customer.

The store side display device 10 is provided to display the contents of orders made by the customer on a screen such as a liquid crystal display, etc. The store side input device 9 is equipped with an operation button that is to be operated when the shop assistant has received an order from the customer.

The customer information database 5 in the head office 13 is for accumulating customer information that is information that associates the customer's customer ID and personal information with the orders-made history information of that customer.

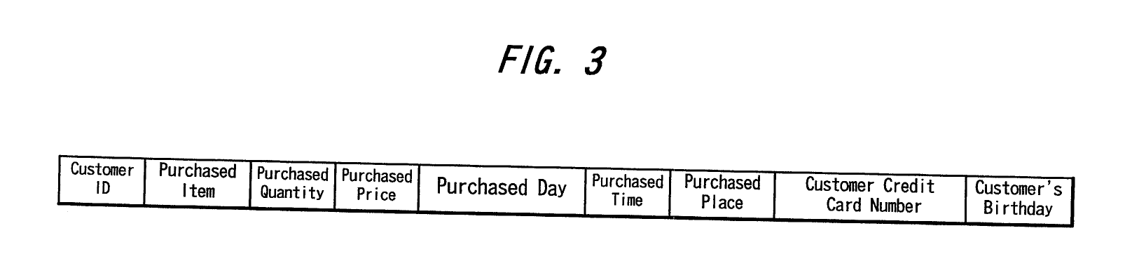

FIG. 3 illustrates items of that customer information. The following are included. “The customer ID” (the customer ID of the customer card 16 or 17), “the items of purchased goods” that are the orders-made history information (the names of the items of food/drink that the customer who has the customer card 16 or 17 has ordered or has answered to the questionnaires), “the quantity of purchase” (the notes “ENQ” indicating how many persons the customer has ordered those items of food/drink for, or indicating that the customer answered those items of food/drink with respect to the questionnaires), “the purchased price” (the price the customer has paid for those items of food/drink), “the purchased day” (the date on which the customer ordered those items of food/drink), “the purchased time” (the time zone within which the customer ordered those items of food/drink) and “the purchased place” (the name of the store 12 where the customer ordered those items of food/drink), “the customer credit card number” that is personal information (the credit card number in the case of the customer card 17 used concurrently as a credit card) and “the customer's birthday (the customer's data/year of birth).

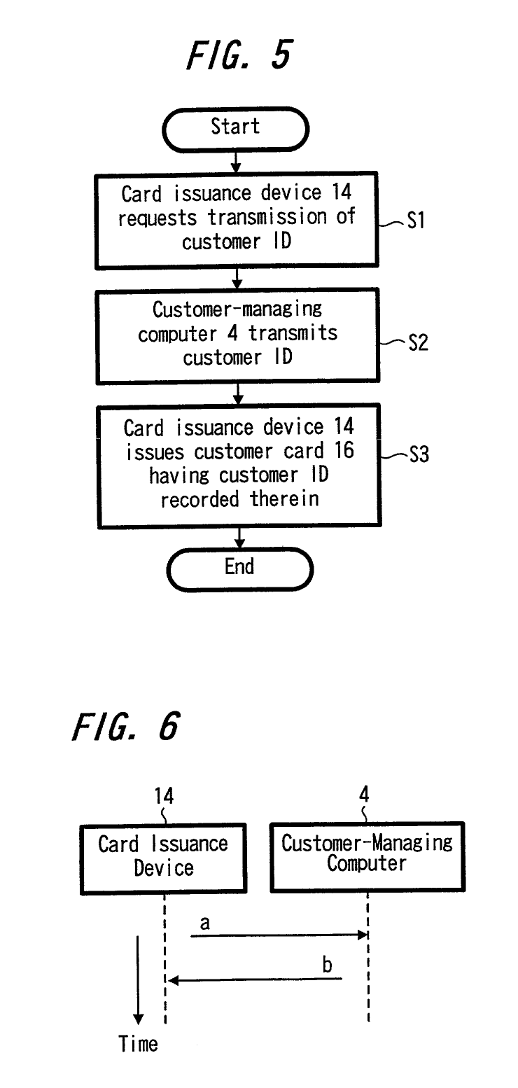

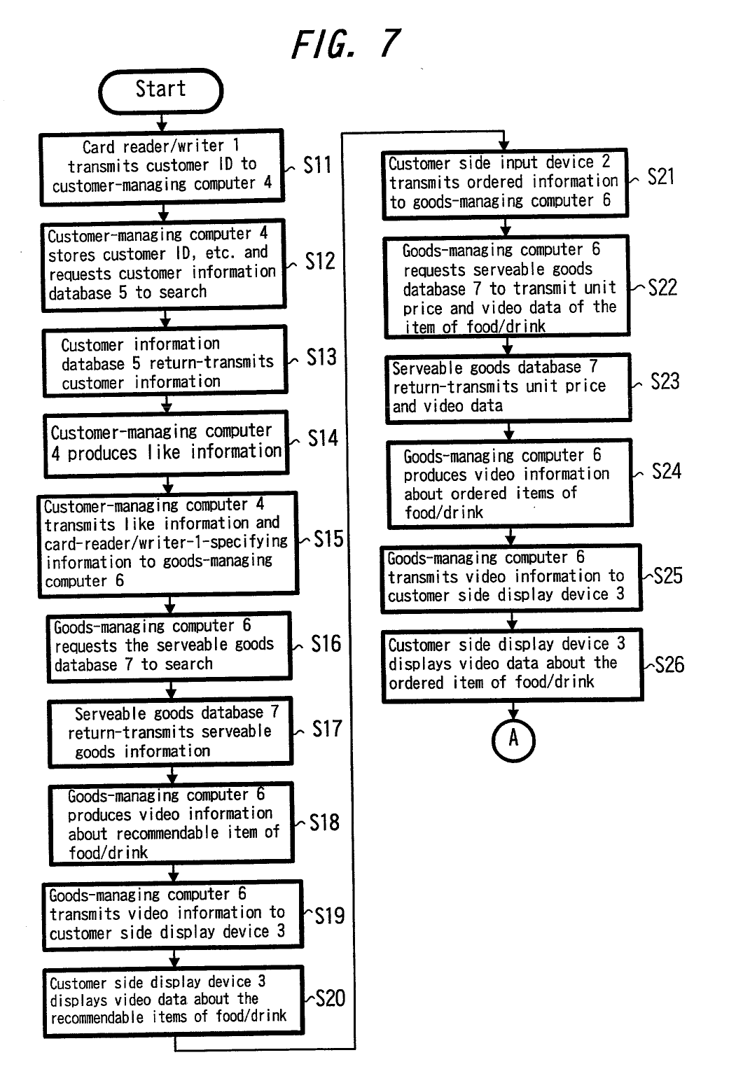

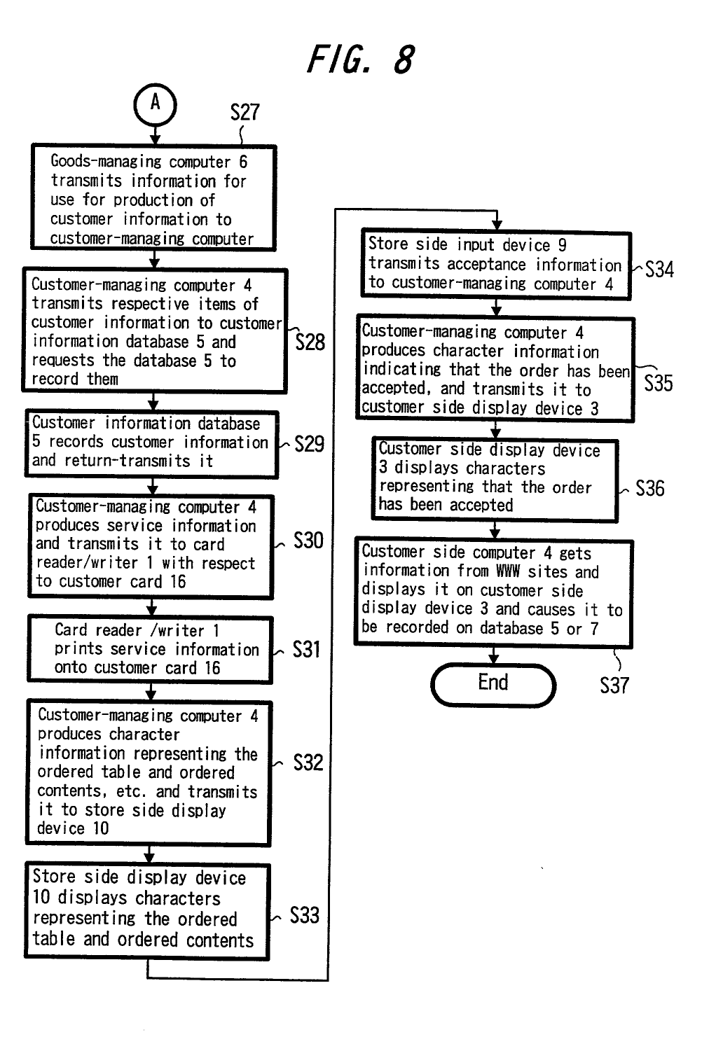

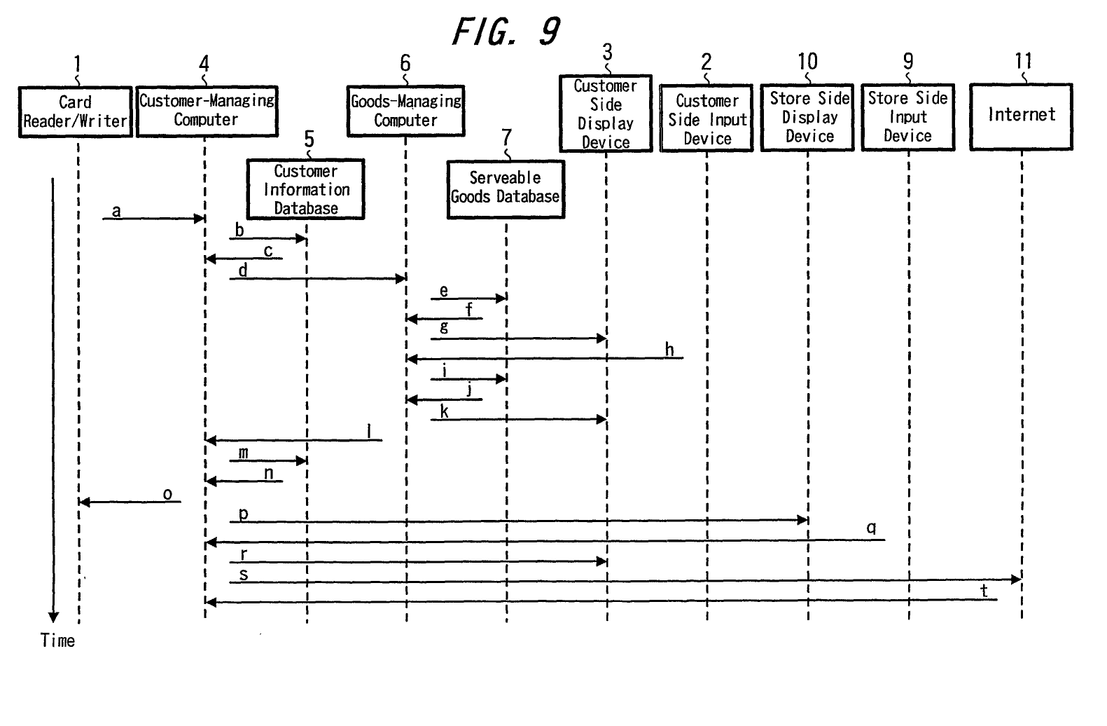

On the customer-managing computer 4 in the head office 13, there are installed pieces of software that perform producing or transmitting/receiving, information, request, etc., such as a customer card issuance process of FIG. 5 and an order-receiving customer-managing process of FIGS. 7 and 8, to which reference will be later made.

On the serveable goods database 7 of the head office 13 there is accumulated serveable goods information that is the information regarding goods (food and drink) that are serveable at present, in every store 12.

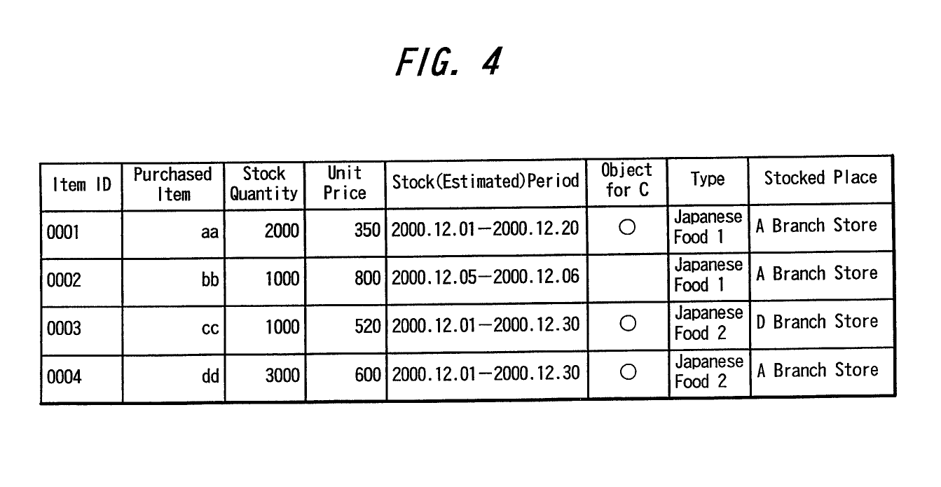

FIG. 4 illustrates items of that serveable goods information and an example of the accumulated serveable goods information. The items of the serveable goods information include “goods item ID” (the IDs of food/drink items each in units of a food/drink item), “purchased goods item” (the names of the purchased food/drink items), “stock quantity” (the number of the relevant food/drink items that are kept in a refrigerator, etc. in the store 12 and that are in a state of being ready for service), “unit price”, “stock period” (the period during which the relevant food/drink items corresponding to the number stocked are ready to be served in the store 12), “object for campaign” (deciding whether the relevant food/drink item is an object for campaign), “type” (the type of the relevant food/drink item sorted out from a plurality of types according to its genre, such as Japanese food, Western food or Chinese food, material, method of cooking, etc.), and “stocked place” (the name of the store 12 that provides the relevant food/drink item).

In the example of FIG. 4, in the A store 12a, the serveable goods information indicating that (aa), which is an item of food/drink whose type is a Japanese food item 1 (one type among Japanese food items) and whose unit price is 350 yen, is possible to be served in an amount corresponding to 2000 people during the period from December 1st to December 20th, A.D. 2000 is accumulated on the serveable goods database 7.

Also, on the serveable goods database 7, video data that have been obtained by photographing the respective food/drink items are also accumulated other than the respective items of FIG. 4.

On the goods-managing computer 6 of the head office 13 there is installed software such as an order-receiving/customer-managing process of FIGS. 7 and 8 which produces, and transmits/receives, information and request.

FIG. 5 is a flow chart illustrating a customer card issuance process that is executed by respective parts of the FIG. 1 system while FIG. 6 is a view illustrating the flows of the items of information and the requests within the FIG. 1 system that occur during that customer card issuance process.

When the operation of requesting the issuance of the customer card 16 is performed in the card issuance device 14 in any one of the stores 12, there is started the customer card issuance process. And initially, the card issuance device 14 transmits a request for transmission thereto of the customer ID to the customer-managing computer 4 via the LAN 15 and the exclusive line network 8 (the step S1 in FIG. 5 and the arrow (a) in FIG. 6).

The customer-managing computer 4 stores therein all of the customers IDs of the customer cards 16 or 17 that have theretofore been already issued, and therefore transmits a new customer ID different from any one of those customers IDs to the card issuance device 14 via the exclusive line network 8 and LAN 15 (the step S2 in FIG. 5 and the arrow (b) in FIG. 6).

The card issuance device 14 records the thus-transmitted customer ID on the customer card 16 or 17 that is an object to be issued (in case the operation of inputting the year and date of birth has been performed in that card issuance device 14, the device 14 records the year and date of birth, too.) And the device 14 sends the thus-recorded customer card 16 or 17 out into a card reception opening (the step S3 in FIG. 5). And the customer card issuance process terminates.

FIGS. 7 and 8 are flow charts each illustrating the order-receiving/customer-managing process that is executed by the respective parts of the system illustrated in FIG. 1 while FIG. 9 is a view illustrating the flows of the information and requests within FIG. 1 system that occur during that order-receiving/customer-managing process.

When the customer card 16 or 17 is inserted into the card reader/writer 1 at the table in any one of the stores 12, that order-receiving/customer-managing process is started. And, initially, by the card reader/writer 1 there is read the customer ID recorded on the customer card 16 or 17 (in case the operation of inputting the year/date of birth has been performed, the recorded information also includes that year/date of birth that is personal information while in case the card is the customer card 17 used concurrently as a credit card the credit card number which is personal information is also read). Then, this customer ID and personal information are sent from the card reader/writer 1 to the customer-managing computer 4 via the LAN 15 and exclusive line network 8 (the step S11 in FIG. 7 and the arrow (a) in FIG. 9).

The customer-managing computer 4 temporarily (until executing the step 28 as later described) stores inside this computer 4 the customer ID and personal information that have been transmitted from the card reader/writer 1. Simultaneously, the computer 4 transmits to the customer information database 5 a request for searching the customer information including that customer ID (the step S12 in FIG. 7 and the arrow (b) in FIG. 9).

The customer information database 5 searches the customer information, containing the customer ID therein, from among the already-accumulated customer information items, and transmits the customer information to the customer-managing computer 4 (the step S13 in FIG. 7 and the arrow c in FIG. 9).

The customer-managing computer 4 produces, according to the customer information sent from the customer information database 5, like information that is information representing the customer's like with respect to the food/drink items (the step S14 in FIG. 7). That like information may be the one that among the items of the customer information illustrated in FIG. 3 includes, for example, only the information under the “purchased item” (i.e. the one that includes only the name information of the item of food/drink that the relevant customer ordered, or answered the questionnaire, in the past). Or it may be the one that include the “purchased item” and the “purchased quantity” (i.e. the one that includes the information, as well, that represents the number by which the relevant customer ordered the item of food/drink in the past). Or it may be the one that includes the information under the “purchased item” and the “purchased time” (i.e. the one that includes the information, as well, that represents the time zone during which the relevant customer ordered the item of food/drink in the past). Or it may be the one that includes the “purchased item” and the “purchased price” (i.e. the one that includes the price-zone information, as well, through which the relevant customer ordered the item of food/drink in the past).

Incidentally, as another example of the steps S12 to S14, the following procedures may be adopted. Namely, the customer-managing computer 4 gets the already-accumulated customer information items from the customer information database 5, periodically (for example at a fixed time every day). The computer 4 then produces the like information about every customer ID according to that customer information, and keeps stored therein that like information. Then, each time the computer receives in the step S11 the customer ID and personal information transmitted from the card reader/writer 1, the computer 4 temporarily stores therein that personal information and then reads out the like information from within the computer 4.

The customer-managing computer 4 transmits that like information and information for specifying the card reader/writer 1 that transmitted the customer ID and personal information (that information represents which table in the store 12 in which place the relevant card reader/writer 1 is located at), to the goods-managing computer 6 via the exclusive line network 8 (the step S15 in FIG. 7 and the arrow (d) in FIG. 9).

The goods-managing computer 6 transmits, according to the like information transmitted from the customer-managing computer 4 and the information representing in which place the relevant store 12 is located, a request for searching the item of food/drink to the serveable goods database 7 (the step S16 in FIG. 7 and the arrow (e) in FIG. 9).

The searching condition of that searching request, for example, may be the one that causes the searching of only an item of food/drink that among the items of food/drink able to be now served in the relevant store 12 is included in the like information as under the “purchased item”. Or it may be the one that causes the searching of that item of food/drink, and the same “type” or an approximately same type of that item of food/drink among the FIG. 4 items of the serveable goods information. Or it may be the one causing the searching of the item of food/drink, in addition to that item of food/drink, the material and production center of that are common to those of that item of food/drink. Or it may be the one causing the searching of only the item of food/drink, among that items of food/drink, concerning that, according to the like information, the time shown as the “purchased time” coincides with the present zone of time (namely the item of food/drink that is matched with the like depending on a zone of time). Or it may be the one causing the searching of the item of food/drink, in addition to that item of food/drink, that, although being not included under the category of this item of food/drink, is being shown as an item of food/drink for campaign that falls under the item “C campaign object” among the items of the serveable goods information.

Further, in a case where items of food/drink (e.g. birthday cake, champagne, etc.) for being served in celebration of a birth day are handled in each store 12 and where the present date is near to the “customer's birthday” that is among the items of customer information in FIG. 3, the searching condition may be the one causing the searching of the item of food/drink, in addition to that item of food/drink, that is intended to celebrate the customer's birthday.

The serveable goods database 7 searches the serveable goods information about the items of food/drink that satisfy the searching condition, from the already-accumulated serveable goods information and return-transmits that serveable goods information to the goods-managing computer 6 (the step S17 in FIG. 7 and the arrow (f) in FIG. 9).

Using the searched results that have been transmitted from the serveable goods database 7, the goods-managing computer 6 produces video information about the item of food/drink that the store 12 recommends the customer to take (the step S18 in FIG. 7). The computer 6 produced that video information for example by superimposing, upon the video data of the relevant item of food/drink, the characters which represent the purchased item” (the name of the item of food/drink), those which represent the “unit price”, those which indicate that the relevant item of food/drink is an object for campaign, those which indicate that the relevant item of food/drink is the one that the store 12 recommends the customer to take, etc. Also, in case such searched results have been transmitted regarding a plurality of food/drink items, the goods-managing computer 6 simultaneously produces the video information that displays the images about a plurality of those food/drink items in the way they are shown divided on one screen.

Incidentally, when the issued customer card 16 or 17 has initially been inserted into the card reader/writer 1, the customer information, wherein the orders-made history information is associated with the customer ID and personal information recorded in that customer card 16 or 17, has not been accumulated on the customer information database 5 yet. Therefore, in the step S13, the orders-made history information is not transmitted to the customer-managing computer 4. In such a case, in place of the steps S14 to S18, for example, the goods-managing computer 6 transmits to the serveable goods database 7 a request for searching suitable items of food/drink (e.g. all items of food/drink that can be served at present in the relevant store 12 or part of items of food/drink such as those for campaign). Then, the computer produces the video information about the recommendable items of food/drink by the use of the searched results.

Subsequently, the goods-managing computer 6 transmits the video information about those recommendable items of food/drink via the exclusive line network 8 and LAN 15 to the customer side display device 3 at the table in the store 12 that has been indicated by the information specifying the card reader/writer 1 that has been transmitted from the customer-managing computer 4 (the step S19 in FIG. 7 and the arrow (g) in FIG. 9).

As a result of this, the video information about the recommendable items of food/drink is displayed on the customer side display device 3 at the table having had the customer card 16 or 17 inserted into its card reader/writer 1 (the step S20 in FIG. 7).

Subsequently, with respect to the customer side input device 2 of that table, the operation of selecting the item of food/drink and its purchase quantity from among the items of food/drink that have been displayed on the customer side display device 3 and also the operation of finally deciding the contents of the order are performed. Then, the order information that represents the contents of the order (the name of the food/drink item and the quantity of the purchase) is transmitted from that customer side input device 2 to the goods-managing computer 6 via the LAN 15 and the exclusive line network 8 (in a case where the operation of answering the questionnaire has been performed through the use of the customer side input device 2, the information that represents the item of food/drink answered with respect to the questionnaire is also transmitted to the computer 6, too). (The step S21 in FIG. 7 and the arrow (h) in FIG. 9)

The goods-managing computer 6 transmits to the serveable goods database 7 a request for transmitting the “unit price” under the serveable goods information in FIG. 4 that regards the item of food/drink indicated by that order information (i.e. the ordered item of food/drink) and the video data of that ordered item of food/drink (the step S22 in FIG. 7 and the arrow (i) in FIG. 9).

The serveable goods database 7 return-transmits that unit price and the video data to the goods-managing computer 6 (the step S23 in FIG. 7 and the arrow (j) in FIG. 9). using that unit price and video data, and also the orders-made information, the goods-managing computer 6 produces video information about the item of food/drink the order for which has been made (the information prepared by superimposing the characters, representing the name, unit price, purchase quantity, etc. upon the video data of that item of food/drink) (the step S24 in FIG. 7). Then, the goods-managing computer 6 transmits that video information to the same customer side display device 3 which has been refer-red to in the step S19 via the exclusive line network 8 and the LAN 15 (the step S25 in FIG. 7 and the arrow (k) in FIG. 9).

As a result of this, this time, the images of the item of food/drink the order for which has been made are displayed on the customer side display device 3 at the table having the card reader/writer 1 into which the customer card 16 or 17 has been inserted (the step S26 in FIG. 7).

Also, the goods-managing computer 6 transmits the following information to the customer-managing computer 4 via the exclusive line network 8 as the information for accumulating the customer information of FIG. 3 (the step S27 in FIG. 8 and the arrow (1) in FIG. 9). Namely, that unit price information and order information, the information for specifying the customer side input device 2 that has transmitted that order information (the information that indicates at which table in the store 12 in which place the relevant customer side input device 2 is located), and the serveable goods information that has been transmitted in the step S17 from the serveable goods database 7 (the serveable goods information that was searched for according to the like information).

The customer-managing computer 4 multiplies that unit price by the purchase quantity shown by that order information to thereby calculate the purchased price. And the customer-managing computer 4 transmits the following information to the customer information database 5. Namely, the purchased item, purchased quantity, purchased price and the store 12 indicated by the information for specifying the customer input device 2, the customer ID or personal information (the year/date of birth and the credit card number)temporarily stored in the step S12, and the present year/date and time information. Also, simultaneously, the customer-managing computer 4 transmits a request to this customer information database 5 for causing the customer information database 5 to record the following customer information (the step S28 in FIG. 8 and the arrow (m) in FIG. 9). Namely, that information is the customer ID handled as the “customer ID” falling under the FIG. 3 items, the purchased item handled as the “purchased item” falling under the FIG. 3 items, the purchased quantity handled as the “purchased quantity” falling under the FIG. 3 items, the purchased price handled as the “purchased price” falling under the FIG. 3 items, the present year/date handled as the “purchased day” falling under the FIG. 3 items, the present time handled as the “purchased time” falling under the FIG. 3 items, the store 12 handled as the “purchased place” falling under the FIG. 3 items, the credit card number handled as the “customer credit card number” falling under the FIG. 3 items, and the year/date of birth handled as the “customer birth year/date” falling under the FIG. 3 items.

The customer information database 5, according to this request, records therein the customer information, and return-transmits the thus-recorded customer information to the customer-managing computer 4 (the step S29 in FIG. 8 and the arrow (n) in FIG. 9).

Also, in a case where the personal information transmitted from the card reader/writer 1 contains no credit card number (namely when the customer card that has been inserted into the card reader/writer 1 is the customer card 16 having the printing area 22 of FIG. 2), using the order information or searched result (the serveable goods information that has been searched according to the like information) which has been transmitted from the goods-managing computer 6 in the step S27, the computer 4 produces the following service information. Namely, information comprised of characters, figures, symbols, etc. representing the names, unit prices, etc. of the items of food/drink matching with the customer's like or the items of food/drink that are objects for campaign. Then, the computer 4 transmits that service information to the card reader/writer 1 at the table in the store 12 that has been indicated by the information for specifying the customer side input device 2 (the step S30 in FIG. 8 and the arrow (o) in FIG. 9).

In the card reader/writer 1, that service information is printed in the printing area 22 of the inserted customer card 16 shown in FIG. 2 (the step S31 in FIG. 8)

Also, using the order information and information specifying the customer side input device 2, which has been transmitted from the goods-managing computer 6 in the step S27 the customer-managing computer 4 produces the character information that represents the table at which a relevant order has occurred and the contents of the order (the names and purchased quantity of the ordered items of food/drink). Then, the computer 4 transmits that character information to the store side display device 10 in the store 12 that is indicated by the information for specifying the customer side input device 2, via the exclusive line network 8 and the LAN 15 (the step S32 in FIG. 8 and the arrow (p) in FIG. 9).

As a result of this, the characters that indicate the table, where the order has occurred, and the order contents are displayed on the store side display device 10 in the place where the shop assistant of that store 12 is waiting (the step S33 in FIG. 8).

Subsequently, upon operation of the store side input device 9, acceptance information indicating that the shop assistant has accepted the order is transmitted from the store side input device 9 to the customer-managing computer 4 via the LAN 15 and the exclusive line network 8 (the step S34 in FIG. 8 and the arrow (q) in FIG. 9).

The customer-managing computer 4 produces character information representing the acceptance of the order according to that acceptance information. And, the computer 4 transmits that character information to the customer side display device 3 at the table in the store 12 indicated by the information for specifying the customer side input device 2, via the exclusive line network 8 and the LAN 15 (the step S35 in FIG. 8 and the arrow (r) in FIG. 9)

As a result of this, this time, the characters representing that the order has been received are displayed on the customer side display device 3 of the table where the customer card 16 or 17 has been inserted into the card reader/writer 1 (the step S36 in FIG. 8).

Also, the customer-managing computer 4 gets various items of information from the WWW site by accessing the Internet 11 (the arrows (s) and (t) in FIG. 9), and the computer 4 transmits and causes the customer side display device 3 to display those items of information. Or the computer 4 transmits them to the customer information database 5 or the serveable goods database 7 and thereby causes them to be recorded there in association with the customer information and goods offer information (the step S37 in FIG. 8).

As the example of the information that the computer 4 gets from the WWW site, there can be information associated with the ordered item of food/drink, which regards the features or production center of the material of that item of food/drink, or information about that item of food/drink that regards a delicious way of eating it, or information regarding the table manner when a person eats that item of food/drink.

In addition, there can be information regarding means by which the customer goes home, which includes information on the service time schedule of trains or buses at the station or bus stop nearest to the store 12.

And when, for example, the customer 16 or 17 having been inserted into the card reader/writer 1 is drawn off from this card reader/writer 1, the order-receiving/customer-managing process terminates.

Next, a state where the order reception and the customer management are performed through the operation of the system will be described in more detail.

When some customer (who is assumed here to be the customer AA) has performed, using the card issuance device 14 in any one of the stores 12, the operation of requesting the issuance of the customer card 16 or 17, the customer card issuance process of FIG. 5 is executed. As a result of this, there is issued from the card issuance device 14 the customer card 16 having recorded therein a customer ID different from any of the customer cards 16 that have theretofore been already issued (in a case where the customer AA also has performed the operation of inputting the year/date of birth, the customer card 16 having recorded therein the customer AA's year/date of birth as well is issued).

Or, when the customer AA has requested the issuance of the customer card 17 used concurrently as a credit card, in writing, etc., there is issued the customer card 17 that has recorded therein a customer ID different from any one of the customer IDs of the theretofore-issued customer cards 16 or 17, the customer AA's year/date of birth, and the recorded information of the ordinary credit card.

Here, it is assumed that the customer card 17 has been issued with respect to the customer AA. When the customer AA goes to any one of the stores 12 and initially inserts that customer card 17 into the card reader/writer 1 at the table where the customer AA had a seat, there are executed the steps S11 to S20 of the order reception/customer management process in FIGS. 7 and 8. (However, in this case, unlike the case stated above, since no customer information about the customer AA is accumulated on the customer information database 5, video information of all items of food/drink presently serveable in that store 12 or of part of items of food/drink such as the object for campaign is produced instead of the steps S14 to S18.) As a result of this, video data of all items of food/drink presently serveable in that store 12 or, of part of items of food/drink such as those which are the objects for campaign is displayed as recommendable items of food/drink on the customer side display device 3 of the table where the customer has seated himself or herself.

When the customer AA performs, while seeing the display of the customer side display device 3, the operation of selecting the item of food/drink the customer intends to order and the purchase quantity of them as well as the operation of finally deciding the contents of this order, there are executed the steps S21 to S26 of the order reception/customer management process of FIGS. 7 and 8. As a result of this, video data about the ordered item of food/drink, this time, is displayed on the customer side display device 3 at the table where the customer AA has had a seat. Thereby, the customer AA can confirm the contents the customer has ordered himself or herself.

Along with this, through the execution of the steps S27 to S29 of the order reception/customer management process of FIGS. 7 and 8, the customer information associated with the customer ID and personal information (the year/date of birth and the credit card number) of the customer AA and the orders-made history information is accumulated on the customer information database 5.

Along with this, through the execution of the steps S32 to S33 of the order reception/customer management process of FIGS. 7 and 8, the characters indicating that an order has been made at the table where the customer AA has had a seat and indicating the contents of this order are displayed on the store side display device 10 at the place of the store 12 where the shop assistant is waiting. Thereby, the shop assistant can quickly know, while staying at the waiting place, that the order has occurred at that table and, in addition, the contents of that order.

When the shop assistant who has viewed that store side display device 10 operates the store side input device 9, the order reception/customer management process of FIGS. 7 and 8 executes its steps S34 to S36. Thereby, the characters indicating that that order has been accepted, this time, are displayed on the customer side display device 3 at the table where the customer AA has had a seat. Thereby, the customer AA can know that his or her order has been accepted or received.

In this way, while staying at the waiting place, the shop assistant can quickly receive the order made by the customer AA without going to the table, as in the prior art, where a relevant calling bell has rung. Accordingly, on the customer AA's side, there is no need to wait some relevant length of time until the customer AA makes an order.

In addition, the card reader/writer 1 of the table at which the customer AA has had a seat can be used also as the card reader for the customer card 17 serving as a credit card. Therefore, when having the bill checked utilizing the customer card 17 serving as a credit card, the customer AA can finish reading of the recorded information of the credit card on the spot. Accordingly, unlike the case where, as in the prior art, the customer AA puts the credit card in the shop assistant's keeping and waits for the reading, by the card reader in another place, of that recorded information, the customer AA's waiting length of time when the bill is checked, also, becomes short.

When the customer AA thereafter goes to any one of the stores 12 again and inserts the customer card 17 into the card reader/writer 1, since this time the customer AA's orders-made history information is accumulated on the customer information database 5, as the recommendable items of food/drink the following images are displayed on the customer side display device 3 at the table where the customer AA has had a seat through the execution of the steps S11 to S20 of the order-receiving/customer-managing process of FIGS. 7 and 8. Namely, the images including the items of food/drink of the previous order, the items of food/drink whose type is the same as, or approximately the same as, that of those items of food/drink on the serveable goods database of FIG. 4, and the items of food/drink for campaign.

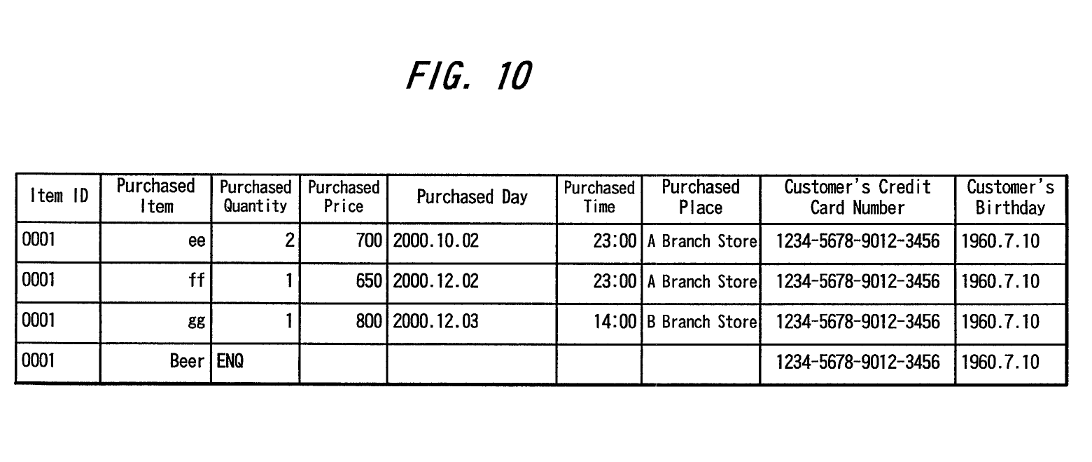

FIG. 10 illustrates an example of the customer information about the customer AA that has been accumulated on the customer information database 5 after the customer AA went to the stores 12 some times. In the example, there are recorded the customer ID 0001 of the customer card 17 that has been issued to the customer AA, the customer's year/date of birth, Jul. 10, 1960, that is personal information of the customer AA, and the customer's credit card number 1234-5678-9012-3456. Also, there are recorded as the orders-made history information associated with that customer ID and personal information, the fact that the customer AA ordered Japanese food ee in an A branch store 12a at 23:00 o'clock on Oct. 2, 2000, in a quantity of two sets corresponding to two persons and paid 700 yen, the fact that the customer ordered ff (Japanese food) in the A branch store 12a at 23:00 o'clock, Dec. 2, 2000 in a quantity of one set corresponding to one person and paid 650 yen, the fact that the customer ordered gg (Western food) in a B branch store 12b at 14:00 o'clock, Dec. 3, 2000, in a quantity of one set corresponding to one person and paid 800 yen, and the fact that the customer answered beer with respect to the questionnaire.

From this customer information it is seen that the customer AA likes Japanese food late at night (especially, that, because the customer ordered ee in a quantity of two sets corresponding to two persons, the customer AA likes Japanese food of specific taste), that the customer likes to take Western food at noon, and the customer likes beer.

It is assumed now that, in a state where this customer information such as that illustrated in FIG. 10 is accumulated on the customer information database 5 and the serveable goods information such as that illustrated in FIG. 4 is accumulated on the serveable goods database 7, the customer AA went, for example, late at night, to the A branch store 12a and inserted the customer card 17 into the card reader/writer 1. In this case, in the step S14 of the order-receiving/customer-managing process, there is produced like information that includes, for example the ee, ff, gg, and beer as the purchased-item information and the purchased-quantity, and purchased-time, information about the ee, ff, and gg. And, in the step 17 of the order-receiving/customer-managing process, among the items of food/drink able to be presently served in the A branch store 12a, for example, the following serveable goods information is transmitted from the database 7 to the display device 3. Namely, the serveable goods information about the aa which is a specific taste of Japanese food that the customer AA likes especially in the mid time zone of night and which simultaneously is among the object items of food/drink for campaign. Accordingly, in the step S20 of the order-receiving/customer-managing process, the images of, for example, the aa item are displayed on the customer side display device 3.

In this way, after the customer AA has once been to the store 12 in any one of the relevant places, whichever store in any relevant place the customer AA goes to (for example even when the customer doesn't go to the A branch store 12a but goes to the store 12 in a first place such as the C branch store 12c), there are displayed the images of the items of food/drink matched with the customer AA's like or of the items of food/drink being the object for campaign. Therefore, the customer AA's desire to order is increased. Accordingly, it is possible to perform customer management which would more increase the customer AA's desire to order than the conventional uniform customer management arranged to give the customer the points corresponding to his or her ordered amount of money.

Further, although an example wherein there is used the customer card 17 serving concurrently as a credit card has been described here, in a case where the customer card 16 is used, the following results. Namely, in that case, as has been stated above, the steps S30 and S31 of the order-receiving/customer-brought to the customer's ordering table. It may thereby be arranged that, according to the operation of that operation button, the characters representing that estimated length of time as well as the characters representing the fact that the relevant order has been accepted be displayed on the customer side display device 3.

Further, in the above-described example, a magnetic card having coated on the obverse card surface magnetic material is used as the customer card 16 or 17. However, as another example, it may be arranged that an IC card be used as the customer card. In this case, part, or the whole, of the customer information of FIG. 3 accumulated on the customer information database 5 may be recorded in the IC card.

Further, in the above-described example, as the recording medium, there is used a card-shaped recording medium such as the customer card 16 or 17. However, a recording medium of other shape than that of that recording medium (e.g. a stick-shaped recording medium of a smaller size than that of the card) may be used as the recording medium.

Further, in the above-described example, the present invention has been applied for performing order-reception/customer-management in each of the respective stores that are operated by a company running restaurants in a plurality of places. However, the present invention is not limited thereto and may be applied for performing order-reception/customer-management in a single restaurant. In this case, for example, the card reader/writer 1, customer side input device 2, customer side display device 3, store side input device 9, store side display device 10, card issuance device 14, customer-managing computer 4, customer information database 5, goods-managing computer 6, and serveable goods database 7 need only to be connected to the LAN within that restaurant.

In addition, the present invention is not limited to the above-described examples but can of course be applied to clothes, toys, or other goods under various kinds of categories.

As described above, according to the customer-managing system and customer-managing method of the present invention, the effects are obtained of furthering the customer's desire to order and of enabling the customer to quickly find out the goods and/or articles matching with his or her like.

Also, according to the order-receiving/customer-managing system and order-receiving or accepting/customer-managing method of the present invention, there are obtained the effects of strengthening the customer's desire to order and of enabling the customer to quickly find out the goods and/or articles matching with the customer's own like, and the effect of enabling the shop assistant to promptly receive the order that has been made by the customer.

In addition, according to the order-receiving/customer-managing system and order-receiving/customer-managing method, the effect if also obtained of, each time the customer orders the goods and/or articles, enabling the identification information and orders-made history to be automatically stored by associating the former with the latter.

Having described prefer-red embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A customer-managing system comprising:
a reading means that reads identification information for identifying a customer from a recording medium having recorded therein said identification information,
a display means that displays information about serveable goods and/or articles served as the performance of the service,
a first storage means for storing therein said identification information and an orders-made history information, by associating the former with the latter, representing the history of the orders made by the customer identified by the identification information on said goods and/or articles,
a second storage means that has stored therein information about a plurality of said goods and/or articles, and
a processing means that, based on said orders-made history information having been stored in said first storage means by being associated with said identification information that has been read by said reading means, selects information about any one or ones of said goods and/or articles from among the information about a plurality of said goods and/or articles that has been stored in said second storage means, and that causes the display means to display, on said display means, the information on said selected goods and/or articles.

2. The customer-managing system according to claim 1, wherein said article is an item of food/drink.

3. A customer-managing method comprising:
an issuance step that issues a recording medium having recorded therein identification information for identifying a customer;
a first storage step for storing therein said identification information and an orders-made history information, by associating the former with the latter, representing the history of the orders made for goods and/or articles by the customer identified by said identification information;
a second storage step that has had stored therein information about a plurality of goods that are served and a plurality of articles that are served as the performance of service;
a read step that reads out said identification information from the recording medium that has been issued in said issuance step;
a selection step that, according to said orders-made history information having been stored in said first storage step by being associated with said identification information that has been read in said read step, selects information about any one or ones of said goods and/or articles from among the information about a plurality of said goods and/or articles as has been stored in said second storage step; and
a display step that displays information about said goods and/or articles that have been selected in said selection step.

4. The customer-managing method according to claim 3, wherein said article is an item of food/drink.

5. An order-receiving/customer-managing system comprising:
a reading means that reads identification information for identifying a customer from a recording medium having recorded therein said identification information;
a first display means that displays information about serveable goods and/or articles served as the performance of the service;
an input means that performs an operation of ordering an item from among said goods and/or articles whose information has been displayed on said first display means;
a second display means that displays the information indicating that an item from among said goods and/or articles has been ordered;
a first storage means for storing therein said identification information and orders-made history information, by associating the former with the latter, representing the history of the orders made by the customer identified by said identification information on the item of said goods and/or articles;
a second storage means that has stored therein information about a plurality of said goods and/or articles;
a first processing means that, based on said orders-made history information having been stored in said first storage means by being associated with said identification information that has been read by said reading means, selects information about any one or ones of said goods and/or articles from among the information about a plurality of said goods and/or articles that has been stored in said second storage means, and that causes said first display means to display the information about the item or items selected from among said goods and/or articles; and
a second processing means that, based on the operation of said input means, causes said second display means to display the information indicating that the item of said goods and/or article has been ordered.

6. The order-receiving/customer-managing system according to claim 5, wherein said article is an item of food/drink.

7. The order-receiving/customer-managing system according to claim 5, fur ther comprising:
a third processing means that based on the fact that the item of said goods and/or articles has been ordered through the operation of said input means produces said orders-made history information and that causes said identification information read by said reading means and said orders-made history information to be stored in said first storage means by associating the former with the latter.

8. The order-receiving/customer-managing system according to claim 7, wherein said article is an item of food/drink.

9. An order-receiving/customer-managing method comprising:
an issuance step that issues a recording medium having recorded therein identification information for identifying a customer;
a first storage step for storing therein said identification information and orders-made history information, associating the former with the latter, representing the history of the orders made for goods and/or articles by the customer identified by said identification information;
a second storage step that has stored therein information about a plurality of goods that are served and a plurality of articles that are served as the performance of service;
a read step that reads out said identification information from the recording medium that has been issued in said issuance step;
a selection step that, based on said orders-made history information having been stored in said first storage step by being associated with said identification information that has been read in said read step, selects information about any one or ones of said goods and/or articles from among the information about a plurality of said goods and/or articles that has been stored in said second storage step; and
a first display step that displays information about said goods and/or articles that have been selected in said selection step; and
a second display step that, based on the operation of said input means for performing the operation of ordering said item of goods and/or articles whose information has been displayed on said first display means, causes said second display means to display the information indicating that said item of goods and/or articles has been ordered.

10. The order-receiving/customer-managing method according to claim 9, wherein said article is an item of food/drink.

11. The order-receiving/customer-managing method according to claim 9, which further comprises:
a production step that based on the fact that the item of said goods/articles has been ordered through the operation of said input means produces said orders-made history information, and wherein
in said first storage step, said identification information and said orders-made history information that has been produced in said production step are stored by associating the former with the latter.

12. The order-receiving/customer-managing method according to claim 11, wherein the item of goods and/or article is an item of food/drink.
